(19) United States
(12) Patent Application Publication
(10) Pub. No.: US 2008/0042422 A1
(43) Pub. Date: Feb. 21, 2008

(54) Removable peel-off sticker that can be removed from the original purchased product to remind you to reorder, restock, buy etc. the product again

(76) Inventor: Peter Nicholas Maluso, Skillman, NJ (US)

Correspondence Address: PETER N. MALUSO, 78 JOHN BLAW DRIVE, SKILLMAN, NJ, 08558, US

(21) Appl. No.: 11/784,762

(22) Filed: Apr. 10, 2007

Related U.S. Application Data
(60) Provisional application No. 60/744,774, filed on Apr. 13, 2006.

(51) Int. Cl. B42D 15/00

(52) U.S. Cl. 283/55

(57) ABSTRACT

Removable peel-off self adhesive sticker is affixed to a product(e.g. consumer goods, industrial goods) during manufacture and distribution so it can be removed and used to reorder, remind, restock, purchase, try advertise, entice the continued purchase of the product. The removable peel-off sticker has a self adhesive backing so it can be placed and/or stuck to any common surface (e.g. piece of paper) and can be repeatedly moved. The removable peel-off sticker is first attached to the product during the manufacture and distribution processes. It can include elements such as the product logo, colors, product name, brand name, customer name etc. The sticker can subsequently be removed (e.g. after the product is purchased) and used to reorder, remind, restock, purchase, try, advertise, entice the purchase of the product. The removable peel-off sticker has a self-adhesive backing so it can be placed and/or stuck to any common surface (e.g. piece of paper wallet, pad, wall and coupon) and can be repeatedly moved.

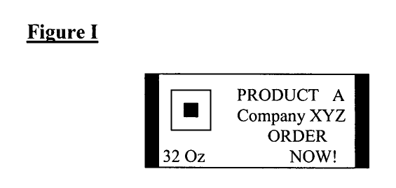

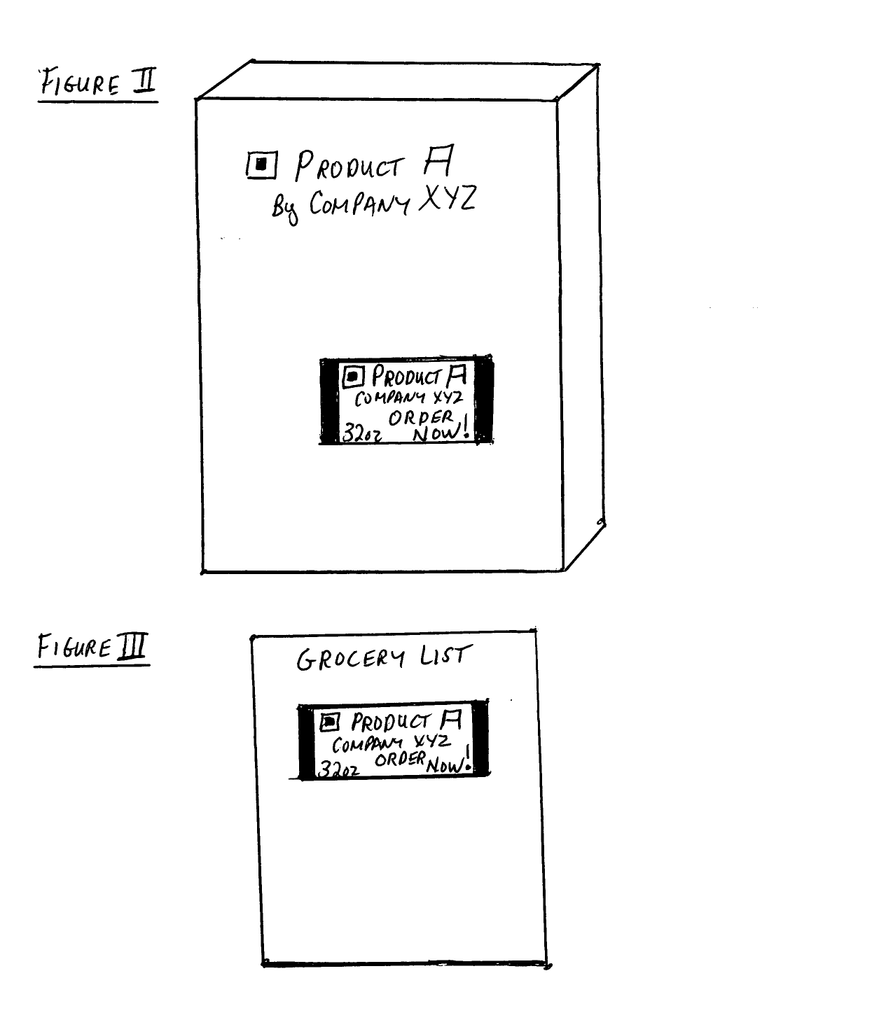

The present invention relates to a removable peel-off sticker that can be removed from the original purchased product to remind you to reorder, restock, buy, etc. the product again. The main component is the removable self-adhesive sticker that can be peeled off and repeatedly affixed to another surface. The size of the self-adhesive peel-off sticker can vary.

The device works by adhering to the original product and having the requisite Information informing the person he/she needs to reorder, remind, restock, purchase, try, advertise, entice the purchase of the product.

The invention can be used with any consumer and industrial product. The information on the peel-off sticker can vary. The removable sticker can be placed on any common surface. How It reminds you to purchase the product again (e.g. on-line, in-store, kiosk) can be different as well. The sticker can be affixed at various points during the manufacture and distribution processes.

The removable sticker can have items such as a bar code (e.g. UPC-A, UPC-E, UPC Suppiementals, Code 39) included in the representation to more precisely define the product (e.g. type of product, manufacturer code, product code). Items such as bar codes can be automatically read during transaction processing (e.g. on-line ordering).

It can an be used with all products including all consumer goods (e.g. paper goods, food, beverage, package goods, toys, drugs/OTC, toiletries, parts, supplies, cleaning goods outdoor/indoor equipment) and all industrial goods (e.g. tools, supplies, parts, outdoor/indoor equipment, materials).

What is claimed is:

1. A removable peel-off sticker that can be removed from the original purchased product to remind you to reorder, restock, buy, etc. the product again. The invention works by being a small representation of the original product (e.g. product logo, product colors, product name, brand name, manufacturer name, size, product type). It adheres to the original product and has the requisite information to remind the person he/she needs the product (e.g. original product is empty). The removable peel off stickers can be aggregated and used for future uses (e.g. store shopping, kiosk shopping, on-line shopping).

2. The device can easily adhere to any product type (e.g. can, bottle, carton, box, container, tray, package) or any product material (e.g. aluminum, tin, metals, glass, plastics, papers, cardboards, cellophanes, hard plastics, polyethylene, wood products).
